(19) United States
(12) Patent Application Publication
(10) Pub. No.: US 2026/0127528 A1
(43) Pub. Date: May 7, 2026

(54) APPARATUS AND METHOD FOR RISK MANAGEMENT IN SALES TRANSACTIONS

(71) Applicant: PROFESSIONAL 6 PTY LTD, Wahroonga (AU)

(72) Inventor: Simon TATE, Turramurra (AU)

(73) Assignee: PROFESSIONAL 6 PTY LTD, Wahroonga (AU)

(21) Appl. No.: 19/382,704

(22) Filed: Nov. 7, 2025

Related U.S. Application Data
(63) Continuation of application No. 18/289,340, now abandoned.

(30) Foreign Application Priority Data
May 5, 2021 (AU) 2021901336

(51) Int. Cl. G06Q 10/0635; G06Q 30/06

(52) U.S. Cl. CPC G06Q 10/0635; G06Q 30/06

(57) ABSTRACT

An electronic apparatus is configured to track risk factors of a real-world event. The apparatus has utility to business-to-business sale transactions such that it reduces the likelihood of lost sales opportunities. The apparatus display's a risk visualization area subdivided into distinct segments, each representing a unique type of risk associated with the real-world event. Each segment indicates a risk level based on inputted or received data relating to the event. The electronic apparatus utilizes an Expert System to improve the accuracy of the inputted data. The apparatus is communicable with a server such that: multiple users may access the same data and receive real-time updates on the event and any associated changes in risk; and the apparatus can communicate with third-party nodes, either to retrieve information or for data analysis, which may be carried out via artificial intelligence (AI). The risk-management is effected using the P6™/methodology.

### CROSS-REFERENCE TO RELATED APPLICATIONS

This application is a continuation of U.S. application Ser. No. 18/289,340, filed Nov. 2, 2023, which is the U.S. national phase of PCT Application No. PCT/AU2022/050419, filed May 5, 2022, which claims priority to AU patent application No. 2021901336, filed May 5, 2021, the disclosures of which are incorporated in their entirety by reference herein.

### TECHNICAL FIELD

The present invention relates to the general field of risk management in sales transactions. The present invention has particular application in the field of risk-management of business-to-business sales processes. However, the present invention may also have utility in other fields.

### BACKGROUND

Conventional business-to-business (B2B) sales processes relating to the sale of goods or services generally have a two-part, “end-to-end” structure having, at one end, a “pipeline methodology” and at the other end a “forecasting methodology”. At the broadest level, pipeline methodology aims to identify and estimate the value of future deals or opportunities that have yet to enter the sales process “pipeline”; while forecast methodology aims to put a dollar value on the revenue that pending deals will actually bring in, in a given time period (such as the current quarter).

A company's pipeline methodology includes the cadence and metrics that sales people are responsible for; the outcome of which are valid or qualified opportunities that can be progressed through a sales cycle. As an example, a company may dictate that every salesperson must create a pipeline value of 3× their annual quota. If a salesperson's annual quota for the product/services they sell is $1 m, then the pipeline creation expectation would be $3 m. If then, the average historical deal size is $100 k, then that would equate to 30 deals. If there are 10 working weeks in a given sales quarter, then in each week, the expectation would be for 3 deals per week to be qualified into the pipeline (i.e., confirmed as opportunities that the salesperson will follow through on/attempt to close). These metrics and expectations form what is referred to as the ‘Pipeline Methodology’. Every company may have a different methodology, but a pipeline methodology is an important bookend to an overall end-to-end sales process.

Once qualified into the pipeline, pending deals are typically referred to as progressing through “Stages”, to indicate how far along they are. For instance, “new” or recently initiated deals may be referred to as Stage 1; while “mature” deals that are close to closing or being finalized may be referred to as e.g., Stage 6 (the exact number of “stages” will differ according to the protocol being used by a company).

The opposite bookend of the conventional B2B sales process is called the Forecast Methodology. It is an equally important part of the sales process but focuses on the metrics that construct an actual dollar-value commitment from a sales person (that is to say, an estimate of how much that sales person can be expected to bring in, in the relevant time frame). The forecast methodology is normally designed as a mathematical extrapolation or series of extrapolations. These factor in, among other things, the value of total available opportunity (i.e., deals in the pipeline) that the salesperson has; and of that, how much is early stage versus mature opportunity. Obviously, mature opportunities that are close to closing will be weighted more heavily in the forecast methodology than early-stage opportunities. An example of a “flawed” forecast methodology would be if a sales person is ‘committing’ $1 m of sales in a given quarter but only has $500 k of total available opportunity, and of that $500 k, most is early stage/non mature opportunities.

Software programs exist which automate, partially or wholly, the B2B sales process; these are commonly referred to as CRM (customer relationship management) programs. Examples of providers of CRM software include Salesforce, Zendesk, ZOHO, Hubspot, SAP AG, Oracle, and Microsoft. Such CRM programs are based around the conventional “end-to-end” structure. They aim to collect/assess available data and produce predictions as to either the “pipeline” and/or the “forecasting” bookend of the sales process.

For instance, one of the popular Salesforce CRM products analyses pending deals to produce a “propensity to buy” score (also referred to as a “CRM score”) for each pending deal, which indicates the likelihood that the deal will successfully close within a deadline specified by the user. The “propensity to buy” score can therefore be thought of as a relative of the “forecasting methodology” aspect of the B2B sales process.

However, conventional B2B sales processes (and CRM protocols) have significant drawbacks in that they consider only the “beginning” and “end” of the sale/purchase process, without having regard to the “intermediate” phase, and the factors and circumstances (and variations in these) that affect the process along the way. This tends to reduce the accuracy of conventional sales/CRM protocols. It may also limit their utility as tools for B2B sales professionals, who are tasked with “shepherding” a deal through the intermediate phase and as such are directly affected by any circumstances/factors which may have an impact on the deal during this phase.

As a result of extensive research, the applicant discovered the importance of taking into account the theme and management of “risk” throughout the life of a pending deal. Furthermore, the applicant discovered that all B2B sales processes can be broken down into 6 key types/areas of risk:
P1: Problem;
P2: Payback;
P3: Pressure Point;
P4: Politics;
P5: Positional;
P6: Process.

Additionally, there is also “P0”, referred to as “Perspective” and evaluated by analyzing market trends affecting the industry/space in which the customer operates, as well as trends pertaining to the individual customer.

The applicant refers to the findings that resulted from this research as “Risk Management Methodology” (RMM). The methodology is marketed under the P6™ brand.

P6™ sits in the middle of conventional sales processes, between the two “bookends” (the pipeline and forecast methodology). It is used post-qualification (i.e., post admission of deals into the pipeline), for the progression of deals through their sales stages until closed. The progression method, which is unique to P6™, is through the lens of “risk”. P6™ helps “derisk” (i.e., reduce or eliminate risk around) sales opportunities as they progress through their “stages”, accelerating deals from early-stage to close. P6™ is particularly valuable in derisking “mature stage” deals, where significant time, effort and expense has typically already been put in by the salesperson, so to lose the deal would entail a significant loss, meaning it is especially important to identify and mitigate risk. Ultimately, P6™ may help significantly improve the accuracy and success of B2B sales processes/CRM protocols.

However, the P6 methodology has certain limitations. Notably, there are limitations on the extent to which it can be practiced in a truly “collaborative” manner, with all relevant internal stakeholders (such as members of the sales team) being able to participate fully in a given sales transaction/pending deal. The P6 methodology is best suited to being carried out by a single salesperson (or at most a small group), so the process does not necessarily benefit from the input of all informed stakeholders. There are also limitations around the amount and origin of data/information that a salesperson is able to access and take into account. It can also be difficult to get an accurate overview, after the fact, of how each of the types of risk, and/or the overall risk, has changed as the sales transaction has progressed, and why.

### SUMMARY

It is accordingly an object of the present invention to provide an improved apparatus (and associated method) for facilitating risk-management in the course of the sales process. At the very least, it is an object of the present invention to provide the public with a useful choice.

### Definitions

Throughout the remainder of this document, the following terms shall have the following meaning:

“Sales process”—means the conventional methodology used by sellers or sales professionals in the sale or offer for sale of goods or services to prospective customers (also referred to variously as “purchasers” or “prospects”), particularly in a business-to-business (B2B) context; and comprising at one end “pipeline methodology” and at the other end “forecasting methodology”;

“CRM”—means software programs used to implement the conventional sales process or aspects of same;

“Sales transaction”, or “deal”—means an instance of using the sales process;

“Pending deal”, or “opportunity”—means a sales transaction that is in progress and has yet to close/be completed;

“Deal cycle” means the lifetime, or duration, of the sales transaction or deal/pending deal, from creation to close;

“RMM”—means Risk Management Methodology, a methodology developed by the applicant for assessing risk associated with a sales transaction between the “pipeline” and “forecasting” phases of the conventional sales process; and

“P6™”—means the RMM methodology and associated educational tools provided commercially by the applicant.

According to one aspect of the present invention, there is provided an electronic apparatus configured to facilitate risk-management during a sales transaction, the apparatus comprising or communicable with a server having a memory, and a processor configured to execute server instructions, the apparatus configured to, in use:
display, on a display region, a risk visualization area subdivided into distinct segments, each distinct segment representing a unique type of risk associated with the sales transaction, and
display, in relation to each segment, an indication of a risk level, the risk level being based on inputted or received data relating to the sales transaction; and
the apparatus further configured to, in response to subsequently inputted or received data, display an updated indication of the risk level in relation to one or more of the segments.

Preferably, the risk-management is effected using the P6™/RMM methodology.

Preferably, the sales transaction is a business-to-business (B2B) transaction.

Preferably, the risk visualization area is configured substantially as a disc or circle.

Preferably, there are 6 distinct segments, corresponding to 6 types of risk associated with the sales transaction, namely: P1 (problem); P2 (payback); P3 (pressure point); P4 (politics); P5 (positional); and P6 (process).

Preferably, at least one of the types of risk is an aggregate of more than one subtype, subcomponent or factor.

More preferably, P6 is an aggregate of 3 subtypes/subcomponents of process risk, namely: a) decision process, b) buying process, and c) internal process.

Preferably, the indication of the risk level associated with each distinct segment is provided by a color code, wherein each color corresponds to a predetermined level of risk.

More preferably, there are 3 risk levels: low or no risk (denoted by green); medium or moderate risk (denoted by orange); and high risk (denoted by red). However, this is not intended to be limiting.

Preferably, an expert system is integrated into the risk management system capable of determining the risk level of each of the 6 segments. The expert system may be hosted either on a remote server or on the user's electronic apparatus.

Preferably, the display region is also configured to display a risk contextualization portion, the risk contextualization portion representing contextual factors potentially impacting one or more of the types of risk.

Preferably, the risk contextualization portion is referred to as “P0” and is provided as an additional, central, segment on the risk visualization area.

Preferably, the contextual factors comprise: one or more market trends affecting the industry/space in which a customer of the sales transaction operates (referred to as “Industry Point of View” (iPOV)); and one or more trends pertaining to the individual customer (referred to as “Account Point of View” (aPOV)).

Preferably, the risk contextualization portion further comprises a “sales proposition” (referred to as an “Assumptive Challenger Proposition” (ACP)), the sales proposition being formed based on the iPOV and aPOV.

Preferably the iPOV, aPOV, and/or ACP are assessed and determined prior to commencement of the sales transaction.

Preferably, the inputted or received data is one or more of:
Contextual factors from the risk contextualization portion, particularly the iPOV and aPOV;
Instructive data inputted by a principal user of the apparatus (the “owner” of the sales transaction) as to risk; such as by the principal user directly specifying the risk level associated with a particular segment;
Indicative data inputted by the principal user and processed by the server in accordance with the P6 methodology to determine its risk implications. For example, the principal user may enter (or select from a multi-choice list) information regarding circumstances surrounding the sales transaction, which the server may process to determine risk levels associated with one or more of the segments;
Instructive or indicative data inputted by authorized users other than the principal user; and
Empirical data stored in or accessible by the server in relation to the sales transaction and processed by the server in accordance with the P6 methodology to determine its risk implications. Empirical data might be entered directly into the system by the user. Empirical data could also be pulled from other computerized sources—for instance, from other CRM systems configured to communicate with the server.

Note that the indicative or empirical data could also be provided via the contextual factors from the risk contextualization portion, particularly the iPOV and aPOV.

Preferably, the subsequently inputted or received data is also data of one or more of the above types; wherein the data is processed by the system to determine whether any changes are required to the risk levels; and wherein, if appropriate, the system displays an updated indication of the risk level in relation to one or more of the segments.

Preferably, the apparatus is configured to communicate with third-party nodes to obtain data (of any of the above types) relevant to the sales transaction. This may be automated, for instance the apparatus may be configured to automatically crawl certain third-party nodes and import relevant information; or it may be actuated manually by the principal user or other contributors.

The analysis/processing of any such inputted or received data, for instance the processing of one or more indicative or empirical items of data to determine their implications for the risk level associated with one or more segments, may be carried out via artificial intelligence (AI) or another suitable protocol. The AI or other suitable protocol may be provided by, or via, a third-party node or facility.

It will be appreciated, therefore, that the apparatus of the present invention is “dynamic” in that it is able to update the visual representation of the risk profile as the sales transaction progresses, based on the most recent data, obtainable in from all relevant sources, and any changes in surrounding circumstances. This is an extremely valuable advantage in the context of the P6™ methodology, given that the crux of P6 is responding to changes in risk levels as they occur, and thereby progressively “derisking” a sales transaction as it progresses. It follows that an apparatus that provides access to real-time, up-to-date information on the transaction, the surrounding circumstances, the attitudes of those involved, et cetera, from a plurality of reliable sources (such as members the sales team as well as other platforms holding relevant data) will optimize the efficacy of P6™ as it enables sales professionals to react more quickly, in a targeted manner, and therefore more effectively, to relevant events.

Preferably, the principal user can indicate one or more other users as authorized users in relation to the sales transaction.

Preferably, the authorized users may be of one or more of the following types: observer and/or contributor.

Preferably, authorized users who are contributors may input data (“contributor-inputted data”), such as instructive or indicative data, relating to the sales transaction. For example, they might propose a change to risk levels as such (e.g. elevating the risk level from green to orange or orange to red; or reducing the risk level from red to orange or orange to green); or they might leave feedback (or provide factual information), like a comment or observation, that causes the principal user to decide to implement a change in risk levels.

Preferably, the contributor-inputted data may be inputted and/or conveyed in one or more of the following forms:
Via a visual indication on the risk visualization area, such as by using “drag-and-drop” functionality, or a drop-down menu, to suggest a different (increased or reduced) risk level;
Via a text box; and/or
Via a voice message.

Preferably, the contributor-inputted data comprises a proposed amended risk level associated with a particular segment. However, this is not intended to be limiting and the contributor-inputted data may be of a different type.

Preferably, the apparatus is configured to work with an expert system (distinct from the aforementioned AI). The knowledge base of the expert system stores information on the key variables in each of the risk segments such that to determine the risk level of a sale, a user may simply respond to a series of questions related to that risk segment. Therefore, the color of a risk factor may be the output of the expert system rather than a direct input from a user. This increases the accuracy of the risk management system as users who are unsure of the appropriate input need not rely on guesswork.

Preferably, the contributor-inputted data triggers a “contributor suggestion or challenge” indication on the display region.

Preferably, the indication includes or provides access to the content of the contributor-inputted data.

Preferably, the indication is visible to the principal user and/or other authorized users.

Preferably, the principal user may accept or reject the contributor-inputted data; wherein, if accepted, the server processes the contributor-inputted data (such as via outsourcing to a third-party node for analysis using AI capability or another suitable protocol) to determine its risk implications and, if appropriate, update the risk level in relation to one or more of the segments; the update(s) being visible to the principal user and other authorized users.

It will accordingly be appreciated that the apparatus of the invention enables true, real-time interaction and input by all members of a sales team, based on the latest information available to each of them. The apparatus collects all input/suggestions/challenges, processes these (if accepted by the principal user) according to the P6™ methodology, updates the risk level accordingly, and immediately displays the updated risk profile to all members of the sales team. Thus, a truly collaborative and real-time approach to the sales process is achieved.

Preferably, the apparatus is further configured to display, on the display region, one or more of:
Selected background data pertaining to the sales transaction, such as the name/identity of the customer, the potential value of the deal, et cetera;
The progress/stage/phase of the transaction; and/or
One or more dates or deadlines associated with the transaction.

Preferably, the apparatus is further configured to store in the memory a history of events associated with the sales transaction.

Preferably, the history includes any changes to the risk levels associated with each segment throughout the course of the sales transaction.

Preferably, the history of the transaction is viewable by the principal user and/or other authorized users.

Preferably, the history of the transaction is viewable at least upon completion of the transaction. More preferably, the history of the transaction is selectively viewable at any point during the transaction.

Preferably, the apparatus is configured to display the history of the transaction, or a selected aspect thereof, on demand, for example by:
Displaying a written summary of the events associated with the transaction or a selected aspect thereof;
Displaying a visualization or visual summary of the events associated with the transaction or a selected aspect thereof; and/or
Displaying an animation or “replay” of events associated with the transaction or a selective aspect thereof.

Preferably, the history of the transaction allows the principal user and/or other authorized users to see how many times each of the types of risk associated with the transaction have changed. The visualization (or animation, or replay) shows a ‘morphing’ of positive risk or negative risk (i.e., an increase or decrease in risk levels) and paints a picture of how the risk profile has changed since the deal was created.

Preferably, where the indication of the risk level is provided by a color code, the history of the sales transaction is displayable as a visualization or animation showing changes in color in relation to each segment throughout the course of the sales transaction.

It will accordingly be appreciated that the apparatus provides members of a sales team, after (or even during) a sales transaction, with a detailed and clear depiction of how the transaction progressed, how risk levels changed throughout the transaction, how various ancillary factors and changes in circumstances impacted on risk levels, and how actions taken by the sales team resulted in changes (such as mitigation) of different types of risk. The apparatus gives users an accurate “cause-and-effect” replay of the transaction and is therefore an effective teaching and learning tool for spotting strategic strengths and weaknesses.

Preferably, the apparatus is further configured with analytics capability, to enable analysis of a completed sales transaction, such as by quantifying the effect of a given circumstance or event on ensuing risk levels associated with one or more of the segments. The analytics capability may be achieved by, or via, a third-party node, such as by utilizing an AI-enabled node for the analysis.

Preferably, the analytics capability is based at least partly on the history of the transaction. Preferably, the analytics capability may be provided in combination with the display of the history of the transaction.

Preferably, the server and memory are remote from the apparatus; such as by utilizing cloud storage.

Preferably, the apparatus comprises a personal electronic device, such as a smartphone, tablet, or laptop; the personal electronic device being programmed with an app configured to communicate with the server and memory.

Preferably, each of the principal user and the other authorized users have access to, and/or provide input via, an apparatus configured as described above. However, this is not intended to be limiting.

Preferably, one or more aspects of the configuration of the apparatus are provided by, or accessible via, one or more third-party nodes or facilities. For instance:
One or more items of the inputted or received data, at the start of the sales transaction or at any subsequent point during the sales transaction, may be sourced from a third-party node or facility (“external data node”), such as a third-party database containing information relating to the customer, the circumstances, contextual factors, the transaction, or any other relevant information. Such importation of data from a third-party node may occur automatically (e.g. the apparatus may be configured to automatically crawl selected third-party nodes and import any relevant information therefrom), or it may occur on the command of the principal user or other user/contributor;
Processing/analysis of the inputted or received data, at the start of the transaction or at any point during the sales transaction, may be done by or via a third-party node (“external processing node”). For instance, but without limitation, third-party AI capability may be utilized for this, with the data being exported, analyzed, and the results then imported;
Communication between the sales personnel (team members) effecting the transaction using the apparatus may occur via one or more third-party nodes (“external communications node”); for instance, inputting of a challenge, suggestion, or data by a contributor, notification to the principal user and potentially to contributors of a new input by a team member, and notification of the response/outcome of the input, may occur via third-party nodes such as via third-party facilitation of text or email notifications;
At the end of the sales transaction (or at an interim point during the transaction), information pertaining to the transaction, such as risk levels, analytics, and playback of the transaction history, may be transmitted to, generated by, and/or accessible via, one or more third-party nodes (“external transaction history analytics node”);
The configuration and capabilities of the apparatus may be obtainable from a third-party provider for download, such as from “App Store” and “Google Play”; or may be hosted by a third-party provider, such as being natively hosted on a site such as saleforce.com; and
Certain security features involving third-party nodes may be incorporated into the configuration of the apparatus, such as multi-factor authentication upon creation of a user account or as part of login by existing users.

According to another aspect of the present invention, there is provided a method for facilitating risk-management during a sales transaction using an electronic apparatus substantially as described above, the method comprising:
displaying a risk visualization area subdivided into distinct segments, each distinct segment representing a unique type of risk associated with the sales transaction, and
displaying, in relation to each segment, an indication of a risk level, the risk level being based on inputted or received data relating to the sales transaction;
the method further comprising, in response to subsequently inputted or received data, displaying an updated indication of the risk level in relation to one or more of the segments.

Preferably, the method comprises receiving input data relating to the sales transaction from a principal user as well as one or more other authorized users.

Preferably, each of the principal user and the one or more other authorized users provide the input data via an electronic apparatus substantially as described above. Accordingly, the method involves the sequential communication/interaction between the apparatuses of each of the users, as well as any third-party nodes via which the risk management process (or parts of same) is effected, including as relates to obtainment of data, analysis of data, and notification of (and/or interaction with) events during the sales transaction.

The present invention accordingly provides a number of advantages, including providing an apparatus (and associated method) for facilitating risk-management in sales transactions (particularly using the P6™ methodology) which:
Enables true, effective, real-time input and collaboration by stakeholders, such as members of a sales team;
Enables all relevant information, from a variety of sources, to be taken into account in the risk profile as it comes to hand, including empirical data relating to the sales transaction and changes in circumstances surrounding the sales transaction;
Thus, enables sales professionals to react more quickly, in a targeted manner, and therefore more effectively, to changes in risk levels or circumstances that may affect risk levels;
Thereby improves the ability to progressively “derisk” sales transactions as they progress, ultimately improving success rates; and
Enables sales professionals to review/replay the progress of completed (or partially completed) sales transactions, to identify critical points in the transaction history vis-à-vis the risk profile; and/or at the very least, provides the public with a useful choice.

### BRIEF DESCRIPTION OF THE DRAWINGS

Further aspects and advantages of the present invention will become apparent with reference to the following Figures, which are given by way of example only and in which:

FIG. 1 is a schematic showing how the P6™ RMM methodology fits into and supplements/enhances conventional sales processes.

FIGS. 2A-2M are schematics showing a preferred exemplary embodiment of the apparatus of the invention, which is the current best method of performing the present invention known to the applicant.

FIGS. 3A-3J are schematics showing the history of a transaction being displayed on the apparatus of FIGS. 2, in the form of an animation or “replay”.

FIG. 4A is an exemplary schematic showing the method of the present invention using the apparatus of the present invention.

Throughout the Figures, like features are indicated by like numerals.

### DETAILED DESCRIPTION

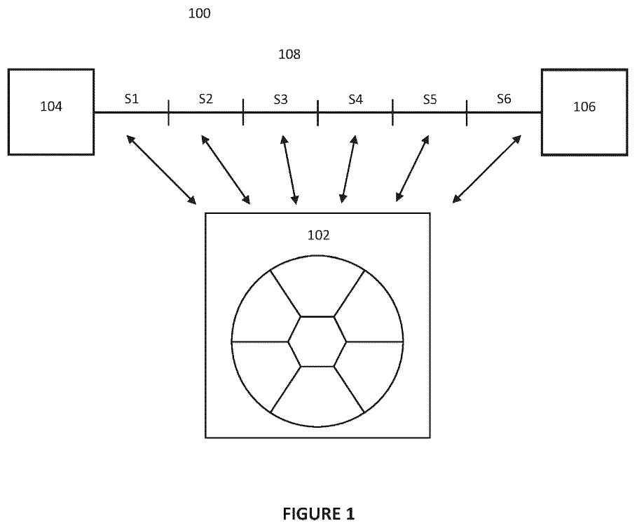

FIG. 1 is a schematic showing how the P6™ RMM methodology (102) fits into and supplements/enhances conventional sales processes (generally indicated by 100).

As noted further above, the P6™/RMM methodology was developed by the applicant following extensive research into conventional Business to Business (B2B) sales processes (100).

Generally speaking, conventional B2B sales processes (100) have, at one end, “pipeline methodology” (104), which aims to determine how many deals a salesperson should be aiming for (i.e. “admitting into the pipeline”) in a given time period on order to meet their target. By way of example, Table 1 below shows what pipeline methodology might look like:

TABLE 1
Basis Pipeline Methodology
“The cadence associated with creating sales opportunity pipeline”

Sales Person Annual Quota = $1m
Average Historical Close Rate = 20
Required Pipeline = $5m
Average Deal Size − $100k
Number of opportunities required = 50

At their other end, conventional B2B sales processes (100) have “forecasting methodology” (106), which aims to estimate the revenue that pending deals will generate in a given time period. An example of this is given in Table 2 below:

TABLE 2
Basic Forecasting Methodology
“The Cadence by which a forecast is created and agreed”

0% of Stage 1 or Stage 2 Current Quarter Pipeline plus
50% of Stage 3 and stage 4 Current Quarter Pipeline plus
80% of Stage 5 and stage 6 Current Quarter Pipeline = $x Forecast
All Current Quarter deals must have a status of ‘Commit’ or ‘Upside’
All Current Quarter deals must note New Cust. Or existing Cust.
All Current Quarter deals must have next steps updated
Forecast must be within 5% of the week 1 call

As seen in Table 2, to enable the forecasting methodology (106) end of the process, pending deals are partitioned into “Stages” (S1-S6 in FIG. 1—collectively indicated by (108)), on the basis that “nascent” or early-stage deals (Stage 1, say) are further from closing than “mature” or later-stage deals (Stage 5 and 6, say). Hence, the later-stage deals are weighted more heavily when estimating the likely revenue in a given time period from pending deals.

However, apart from this high-level assumption that mature deals are generally more “dependable” than nascent deals, the “Stages” into which deals are apportioned under conventional sales process methodologies do not look at any other factors or circumstances influencing a particular deal or its likelihood of success. This omission is one of the major drawbacks of conventional sales processes.

The applicant's research (and the resulting P6™ and RMM methodologies) were targeted at addressing these shortcomings.

In particular, the applicant's research revealed that conventional processes failed to take into account the crucial role of risk in sales transactions, and the effect that changes in risk levels/types/factors had on the success or otherwise of the transaction. The applicant found that that all B2B sales processes can be construed in terms of 6 key types/areas of risk; and further that the 6 areas of risk had a logical pairing (3 pairs of 2).

In the P6™ methodology, the 6 areas of risk are collectively referred to as the “risk lens”, and depicted as wedges/segments on a circle. The collective risk of the transaction represented by all of the wedges/segments is referred to as the “risk profile”, although “risk profile” can occasionally also be used in relation to the risk associated with a single wedge/segment over time.

The seller's overall job throughout the transaction is to strive towards a risk profile that is as low as possible, i.e., all the wedges/segments ideally being at green (low risk), denoting acceptable levels of risk to progress the deal to a close or at least allowing its progression to a later sales stage. Green further denotes a high propensity to buy and/or need to act on the part of the customer/purchaser/prospect.
P1: Problem—This relates to the seller's perceived understanding of the severity of the purchaser's/customer's “problem”, which the seller's goods or services are targeted at solving. It's important to understand the inverse relationship between the severity of the customer's/prospect's “problem” and the risk profile/scoring of P1 for the seller. E.g., if the severity of the “problem” for the customer/prospect is high, then the risk for the seller is low, because the propensity/appetite for the customer to act/purchase the goods or services is high. A practical example of P1 risk would be: If the customer/prospect is a bank and that bank's ‘problem’ is that consumer-facing information on its website relating to interest rates is inaccurate, therefore potentially falling foul of a regulator's consumer disclosure requirements, the bank's ‘problem’, both in the eyes of the seller and buyer, is of a level of severity that the risk to the seller in progressing a deal, assuming their solution is fit to resolve the ‘problem’, is low. The seller would therefore mark P1 as Green (low/no risk) in the risk lens. In the RMM, this type of problem description is called a ‘Universally Structural’ problem i.e. the best problem for a seller to be dealing with and therefore the lowest risk in progressing their deal. The other 2 ‘Problem’ type descriptors are “Aesthetic” and “Situationally Structural”. In the above example of the bank, if the problem, as qualified by the seller, was deemed “Aesthetic”, then the customer's/prospect's sense of urgency to act is diminished and therefore the risk to the seller in progressing a deal is High. The P1 wedge in the risk lens would be changed to Red. A problem that sits somewhere in the middle of the above examples would be deemed “Situationally Structural”. E.g., it is a ‘problem’ for the bank but not so serious that they absolutely need to act on it. The risk to the seller could be denoted as Orange (Moderate Risk to the seller).
P2: Payback—P2 is tightly coupled to P1, referred to in the RMM as a logical pairing with P1. P2 relates to the strength of the expected financial return to the buyer in solving the ‘problem’ (P1). Following the same example as above, the return to the bank of addressing the problem would be to keep their banking license/reduce the risk of losing it. In this instance, the payback, whilst not qualified in absolute dollar terms, is clearly high and again, as per the inverse relationship, would represent low risk to the seller of the goods/services in being able to progress a deal/sale. The risk for P2 in this instance would therefore be marked green. Logical pairs are usually, although not always, the same risk score/color, e.g. If P1 is green, then it is likely P2 will be green. If the Problem (P1) is Green i.e., is deemed a Universally Structural Problem, then the Payback (P2) is likely obvious to see and easily qualified in dollar terms, or risk. It is therefore usual for P1 and P2 to share the same risk profile/color/scoring. This logical pairing was a key theme of the P6 research and is key to the resulting methodology.
P3: Pressure Point—This relates to risk associated with the critical point (or lack thereof) at which the customer makes the decision to buy or not to buy within the timeline forecast by a sales person. Types of P3 risk include: indecision on the part of the customer; the proposed deal falling through the cracks, not remaining on the customer's radar, or being pushed down the list by other, competing matters vying for the customer's attention; the proposed deal being perceived as not “high priority”, or as something that can wait till later or be deferred till cashflow improves et cetera. Put another way, P3 is deemed the point at which the customer/prospect has no choice but to buy. A pressure point normally exists naturally or can be created artificially. An example of a naturally existing pressure point would be if the allocated budget had to be used/committed before a certain date to avoid losing the budget. In this instance, the customer/prospect has an internal compelling event to which to align their purchasing decision. An example of an artificial pressure point is where the seller has proposed a time-sensitive commercial offer that will expire (or increase in cost) post the seller's deadline for signing the deal. E.g. “If you sign this month, the deal is $500 k, but if you sign next month, the deal is $600 k”. In this example the seller is providing incentive for the customer/prospect to accelerate their process. A Green Pressure Point denotes that the deal is very likely to close on or before the seller's forecasted date, as there exists a strong pressure point and/or equal motivation from both seller and buyer to conclude a deal.
P4: Politics—P4 is a measure of the strength of relationships that the seller has with the 4 most important people within the customer's decision or influence base. The P6 RMM research identified that in every B2B sales transaction there are only 4 people within the customer's decision or influence base, at any stage during the deal cycle, from creation to close, that are making the decision or influencing the decision to buy. In assessing P4, the salesperson makes a risk decision about the strength of relationships that he/she has with the 4 identified people within the customer/prospect at every stage in the sales cycle. Again, a Green score denotes that the seller knows the correct 4 people, and that those 4 people have both a positive relationship bias (referred to as RB in the RMM) and a positive buying bias (referred to as BB in the RMM). If the seller scores P4 Orange, it may mean, for instance, that the correct relationships exist, but that the seller has identified buying bias risk with some/all of the relevant 4 people.
P5: Positional—P5 is a measure of the strength of solution/product/service that the seller is representing relative to the competition that the seller faces in the deal. As an example, if the seller is trying to sell 100 Suzuki engines to a boat manufacturer and is competing against Yamaha for the business, then P5 would be scored by the seller based on the perceived strength of the sellers' technical and commercial value proposition. If the seller thinks he/she is losing the deal and/or thinks the competition has a superior product or a more aggressive price, then the risk color would be scored Red. Note, P4 and P5 are a logical pair. The strength, or otherwise, of a sellers' political risk (P4) has a significant bearing on the strength or otherwise of competitive ‘positioning’ (P5).
P6: Process—This relates to risk associated with the customer's processes when it comes to finalizing deals, i.e., committing to the actual purchase, and actioning this. Types of P6 risk include: the customer having poor or unclear processes when it comes to making/authorizing the actual purchasing decision; and/or when it comes to carrying out the administrative processes associated with the decision (such as making payment).

There are 3 areas of P6 risk: A) Decision Process Risk, B) Buying Process Risk and C) Internal Process Risk. A) relates to the process by which the customer/prospect actually arrives at the decision to buy the product/service from the seller e.g. the weighting of the decision to price vs. functionality vs. availability of the product/service vs. local support resources etc. B) relates to the process by which the buyer actually signs a contract and relates to every person and process by which the customer/prospect needs to sign a contract (such as running it past their legal department, for example). Lastly, C) relates to the seller's own internal process for actually having the contract recognized. As an example, the seller may have secured a signed contract but still needs to get internal legal approval to have the contract recognized/booked.

These 3 elements of P6 are usually scored on aggregate by the seller; e.g. green means there is no risk with A), B) or C). However, this is not intended to be limiting and it is conceivable that, in some embodiments of the invention, the 3 elements of P6 could be represented (and scored) distinctly on the risk visualization area. The same holds true for e.g., P4—the risk associated with each of the 4 key people is usually scored on aggregate but could potentially be represented (and scored) distinctly on the P4 segment on the risk visualization area.

As mentioned above, the applicant's research also revealed that these 6 areas can be “paired” as follows: P1:P2; P3:P6; P4:P5.

The applicant's methodology also includes “P0”, which is not a risk type in its own right but rather relates to “Perspective”, that is to say, contextual factors surrounding the deal, which in turn may influence the risk levels associated with P1-P6. P0 helps determine what is referred to in the P6™/RMM methodology as “Carry Risk”, i.e. the risk that a given deal is likely to carry throughout its deal cycle based on “high-level” contextual factors.

Specifically, these contextual factors are iPOV (“Industry Point of View”), which looks at any relevant market trends affecting the industry/space in which the customer operates; and aPOV (“Account Point of View”), which looks at any relevant trends pertaining to the individual customer themselves. iPOV and aPOV are often categorized as “high tide”, “no tide”, or “low tide”. For example, a customer may be operating in a booming space (i.e. iPOV is “high tide”) but may itself be floundering (i.e. aPOV is “low tide”).

From the iPOV and aPOV, which are preferably determined at the very start of the P6™ process, two further things can be derived. Firstly, an ACP, or “Assumptive Challenger Proposition”, which is in the nature of a “pitch” to the customer based on the assessed iPOV and aPOV. In the above example, the ACP might be along the lines of, “our product/service can help you become competitive with your peers in the marketplace”. Secondly, determining iPOV and aPOV as a first step is of great assistance in determining at least the initial risk profile of P1-P6. For instance, in the above example P3 (“Pressure Point”) might be categorized low-risk, since the floundering customer is likely to be highly motivated to get their performance on a par with their competitors, meaning the “Pressure Point” is very much in place.

Returning to the P6™ process generally: by identifying, assessing and closely monitoring each of the 6 key areas of risk throughout a sales transaction, including updating the level of risk as circumstances change, the applicant found that it is possible to progressively reduce the risk associated with the transaction as it moves forward, and ultimately significantly improve the accuracy and success of B2B sales processes/CRM protocols.

More specifically, when an area of heightened risk is identified, the salesperson can then investigate the underlying cause and consider how the risk can be mitigated—for instance by allaying any reservations or concerns the customer has as to the efficacy of the seller's product/service. If another area of heightened risk is subsequently identified later in the process, this, in turn, can be addressed by the salesperson. In this manner, instances of heightened risk can be identified and mitigated on an ongoing basis throughout the life of the deal—“derisking” the deal and making it more likely to close successfully (i.e. conclude with an actual sale). This “derisking” is particularly valuable in the latter stages of the process, when the seller has invested significant resources into progressing the deal so there is a lot to lose if it falls through.

Referring back to FIG. 1, it can accordingly be seen that the P6™ RMM methodology (104) sits between the two “ends” (104, 106) of conventional sales processes (100). That is to say, P6™ RMM methodology (102) operates as an “accelerant” for the deal as it moves through the “stages” (108). When the P6™ RMM methodology (102) is overlaid over the stages (108), it provides a substantive “risk lens” which, as above, helps the salesperson screen for and detect risk as and when it arises, and thereby mitigate/defuse the risk.

There can also potentially be a synergistic effect between the P6™ RMM (102) and the “stages” (108) of conventional sales processes. Not only does P6™ function as a risk-detection tool as the deal is moving through the “stages”—it can also be used to inform/determine, based on assessed risk levels, when a deal should be deemed as having moved to the next stage (“stage progression”) (different levels of risk may be deemed acceptable for a given stage, depending on factors including risk type, surrounding circumstances, et cetera).

However, there remains the limitation that the P6™ RMM methodology, though superior in terms of accuracy and outcome, is best suited to a single salesperson. This is because the methodology is contingent on knowing, with a high degree of accuracy, all relevant facts and circumstances at a given point in time. It can be difficult to obtain such data “manually” without a damaging time-lag. It can be even more difficult for a group of salespeople to all be “on the same page” and fully updated at all times; thus, attempting to effect the P6™ RMM in a group setting entails a risk of miscommunication/misinformation, and thereby error. On the other hand, the sales process tends to be one that benefits from the perspective and analysis of multiple individuals.

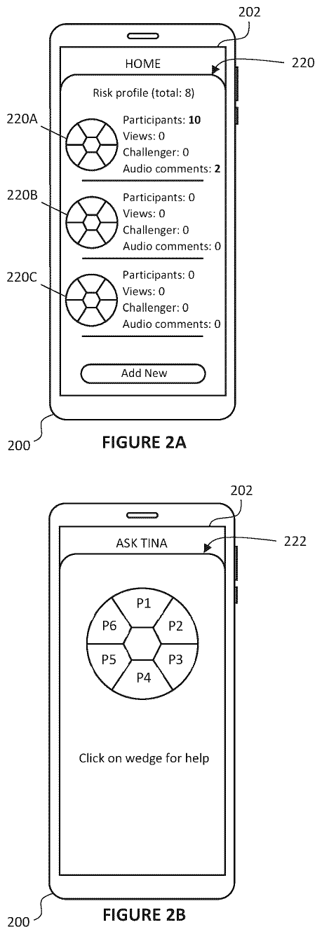

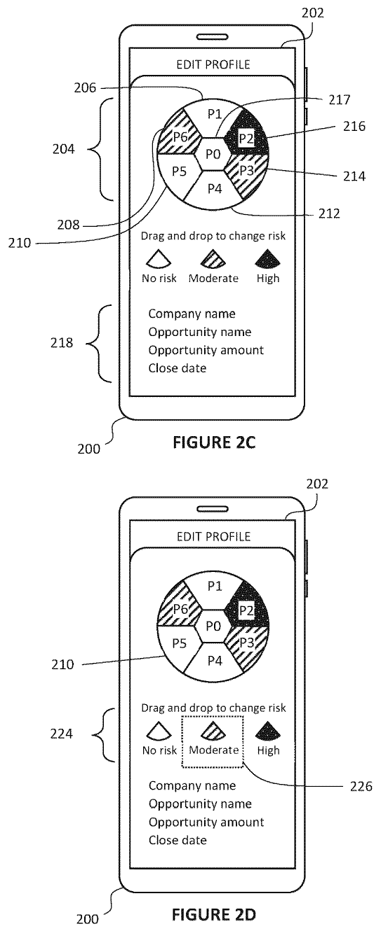

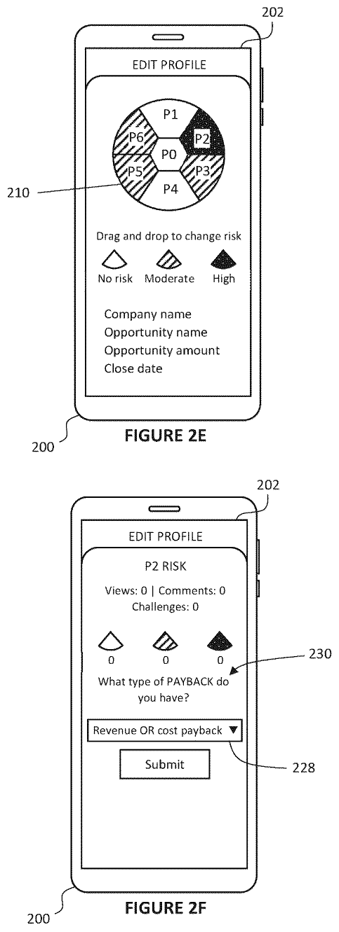

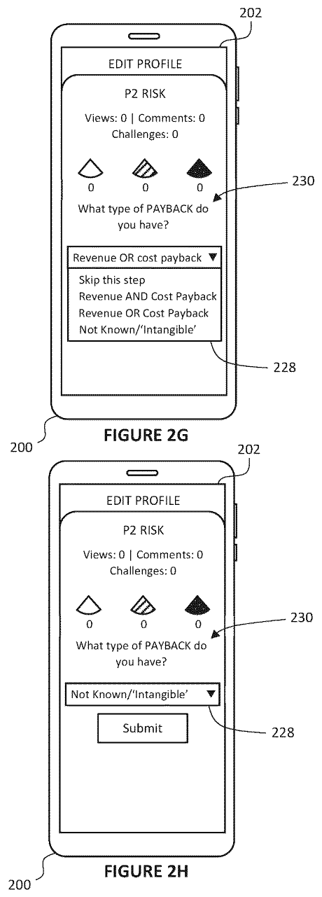

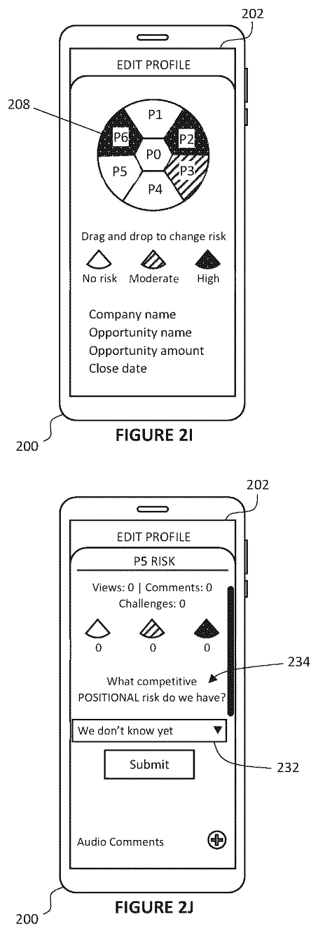

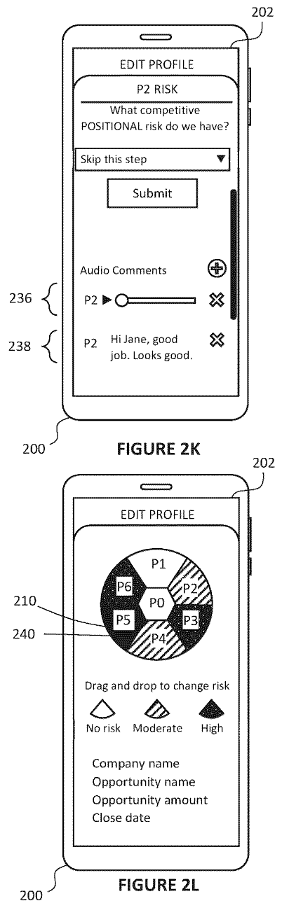

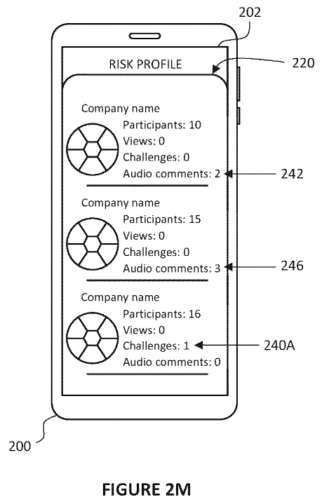

FIGS. 2A-2M are schematic representations of a preferred exemplary embodiment of the apparatus (generally indicated by 200) of the invention, which is designed to enable the P6™ RMM methodology to be effected by a team of salespeople, by allowing all members of the team to near-instantaneously have access to the latest data and information relating to a sales transaction, and allowing all members of the team to communicate/provide feedback that is visible to, and analyzable by, the other members of the team.

The apparatus (200) is provided by or as a smartphone (not shown) configured with an app to facilitate the P6™/RMM process. The apparatus (200) is communicative with a server (not shown) having a memory (not shown)—in this embodiment, the server and memory are remotely hosted by cloud storage. The apparatus also comprises a processor (not shown) configured to execute server instructions.

Referring firstly to FIG. 2C, this best shows the general configuration of the apparatus (200) of the invention. The apparatus comprises a display region (202), in this case provided on the smartphone screen, on which is displayed a risk visualization area (204). In this embodiment, the risk visualization area (204) is provided by the P6™ circular “risk lens”, subdivided into 6 distinct segments (also referred to as “wedges”) (206-216) corresponding to the 6 key types of risk (P1-P6) of the P6™/RMM methodology.

In this embodiment, the risk visualization area (204) also comprises a central segment/region, P0 (217), which is the “risk contextualization portion”. (It will be understood that alternative configurations/presentations/layouts of P0 are possible; for instance, P0 could be provided off to one side of the risk visualization area (204), as opposed to in the center).

As noted above, P0 has 3 contextual factors, or elements, an Industry Point of View (iPOV), an Account Point of View (aPOV) and an Assumptive Challenger Proposition (ACP). The iPOV and aPOV together give an indication of the “carry risk” that a deal will likely have throughout its cycle.

In this embodiment, P0 is not itself assigned a “risk level”, i.e. it is not color-coded on the risk lens. Rather, it is a preliminary assessment that is done by the salesperson, which helps determine “carry risk” and hence inform the risk profile associated with P1-P6. So, in this embodiment P0 shows up “passively” on the display region.

However, in other embodiments, it is possible for the apparatus to display a visual indication of the 3 elements, or contextual factors, of P0. For instance, P0 could contain one or more color-codings, or rankings (these could be entered as a first step by the user). Alternatively, or additionally, hovering over (or touching, in the case of a touch-sensitive screen) the relevant portion of P0 could bring up a text-box containing information on that contextual factor.

Turning now to the risk segments, P1-P6. In this embodiment, consistently with the P6™/RMM methodology, the indication of risk level associated with each of the segments P1-P6 is provided by a color code, with green representing no or low risk, orange representing medium or moderate risk, and red representing high risk (although this is not intended to be limiting and other scoring protocols/indicators are within the scope of the present invention). The risk level is determined based on different types of data relating to the transaction.

In this embodiment, the display region (202) further displays additional information relating to the sales transaction, at the bottom portion (218) of the display region (202): namely the customer name (“Company name”), transaction name (“Opportunity name”), potential value of the transaction (“Opportunity amount”), and a deadline associated with the transaction (“Close date”).

Briefly, FIG. 2A shows that the display region (202) can show a summary page (220) of the various sales transactions (220A, 220B, 220C) of which the user is either the owner (i.e. principal user) or is an authorized user (as an observer and/or contributor). For each of the transactions (220A, 220B, 220C), the summary page (220) shows the risk profile, being the color-coded risk level associated with each segment of the P6™ risk lens. The number of authorized users (“participants”) is also shown for each transaction. There is also the facility for the user to sort/arrange/filter the sales transactions based on their characteristics, such as highest/lowest value, close date, or highest/lowest risk.

In FIG. 2B, the display region (202) is displaying an information portal (“Ask Tina”) (222), via which the user can access the underlying theory and help of the P6™ methodology associated with each of the risk segments.

Referring now to FIGS. 2D-2J, these illustrate some of the different ways in which data relating to the sales transaction may be inputted or received into/by the system, for processing according to the P6™ methodology to determine the risk level associated with each segment.

First referring back to FIG. 2C, it can be seen that P3 (segment (210)) is initially color-coded green, indicating no or low risk, while P2 (segment (208) is initially color-coded orange, indicating medium or moderate risk.

The initial color-coding (i.e. risk indication) of FIG. 2C may be a result of one or more of the below-discussed processes having already been undertaken. The initial color-coding may also be calculated based on the P0 information inputted by the user-such calculation may be done by the user themselves, or automatically by the system. A further possibility is that the system may be configured with a “default” initial color-coding for the various segments, for instance as a result of statistics indicating that certain segments are generally likely to be riskier than others. The “default” initial color-coding may also reflect the above-discussed “pairing” of the risk segments.

Referring now to FIGS. 2D and 2E, these demonstrate a principal user inputting “instructive” data into the system in relation to segment P3 (210)—that is to say, data directly specifying the user's choice of risk level for that segment. In this embodiment, the user does this via a drag-and-drop facility, whereby the user's selected level of risk (here, moderate, (226)), is selected from a risk menu (224) and dragged to segment P3 (210); resulting, as seen in FIG. 2E, in segment P3 (210) changing from green to orange. This updated risk profile will then be visible to the principal user as well as any authorized users viewing the sales transaction on their respective apparatuses.

Referring now to FIGS. 2F-2I, these demonstrate a principal user inputting “indicative” data into the system, this time in relation to segment P2 (208)—that is to say, data relating to the sales transaction which, when processed by the system in accordance with the P6™ methodology, will result in the computation by the system of an appropriate risk level associated with segment P2 (208). In this embodiment, the indicative data is inputted via a selectable dropdown list (228) comprising different options for describing P2 (the question (230) being “What type of PAYBACK do we have?”). In FIG. 2H, the user selects “Not known/Intangible” as the appropriate answer. Based on this, in FIG. 2I the system computes that the risk associated with P2 (208) is accordingly high, and displays an updated risk level indication, with P2 (208) having changed color from orange to red. This updated risk profile will again be visible to the principal user as well as any authorized users viewing the sales transaction on their respective apparatuses. FIG. 2J shows that a similar dropdown list (232, 234) is available for inputting indicative data relating to the other segments; in this case P5 (segment (214)).

Data relevant to the sales transaction need not necessarily be inputted by the principal user (or other users)—it can also be imported from third-party nodes. Depending on the configuration of the system, this may occur automatically-such as, for selected third-party databases, the system being configured to automatically “mine” the databases for any data relevant to the transaction. Or it may occur upon prompting by the principal user or another user, such as a command to search and import data from a particular third-party node.

Computation/analysis of obtained or inputted data, of any type and whether few or many data points, may also be performed by third-party nodes. For instance, once obtained, the data may be outsourced to a third-party node having AI capability, for processing and analysis in accordance with the P6™/RMM methodology to determine the corresponding risk levels associated with one or more of the segments; with the results then being transmitted back to the system.

Referring now to FIGS. 2K and 2L, these demonstrate how other authorized users (specifically, those who are designated as “contributors”, as opposed to just “observers”), may input data relating to the transaction into the system.

In FIG. 2K, it can be seen that one or more contributors have inputted “indicative” data relating to segment P2 (208) in the form of an audio message (236) and a text message (238) giving feedback on the principal user's risk assessment of P2 (208). In this embodiment, such data is inputted by contributors via their respective apparatuses, each configured as per the invention. However, this is not intended to be limiting.

In FIG. 2L, a contributor has inputted “instructive” data, in the form of a direct challenge or suggestion as to what the risk level associated with P3 (210) should be. This is indicated by a “contributor suggestion or challenge” alert, in the form of the P3 segment (210) flashing (240). This will be visible to the principal user, and, in preferred embodiments (though not necessarily), to other authorized users. Note, such instructive data from contributors can (and usually will) be accompanied by one or more other kinds/formats of data, such as indicative data in the way of an explanatory comment (text or audio, similar to FIG. 2K) as to why they propose changing the risk level.

As shown in FIG. 2M, any such data inputted by other authorized users (contributors) will show up as a “contributor suggestion or challenge” alert (242, 246, 240A) in relation to the relevant deal. In preferred embodiments, the alert will also be visible to other authorized users, and will either display, or will provide access to, the content of the input (e.g. an authorized user may view a comment left by another authorized user, or may view the proposed risk level suggested by the authorized user); however, in some embodiments it is possible that only the principal user will be able to view input by other authorized users, at least in the first instance. In preferred embodiments, the principal user will then have the option of accepting or rejecting the authorized user's input. If accepted, the system will process the input to determine any resulting changes in risk level, and will display an updated risk profile, visible to the principal user and authorized users.

From this, it will be appreciated that the apparatus (200) of the present invention provides a very effective tool for implementing the P6™/RMM methodology, that allows not just the “deal owner” (principal user) but also other stakeholders, such as members of the sales team (authorized users), to contribute and collaborate in real time, based on the latest information available to them; and to immediately see changes/suggestions/contributions made by other stakeholders. This enables the P6™/RMM methodology to be utilized with maximum effectiveness, as it allows salespeople to be alerted to, and therefore respond to, changes in risk levels or related circumstances as swiftly as possible, thereby maximizing opportunities for risk mitigation and derisking of the transaction (and ultimately successful closing of the deal).

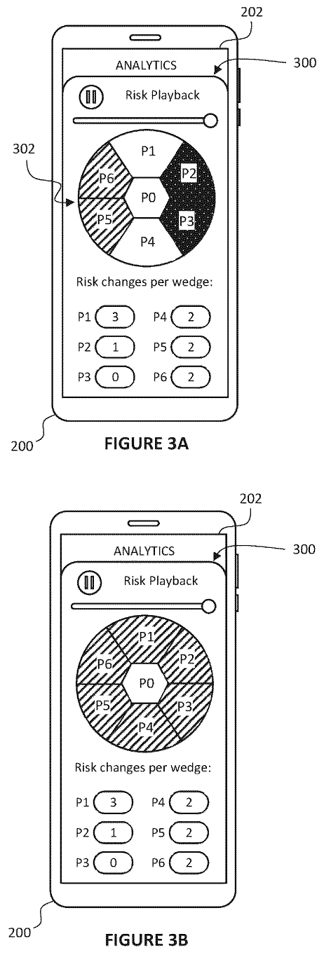

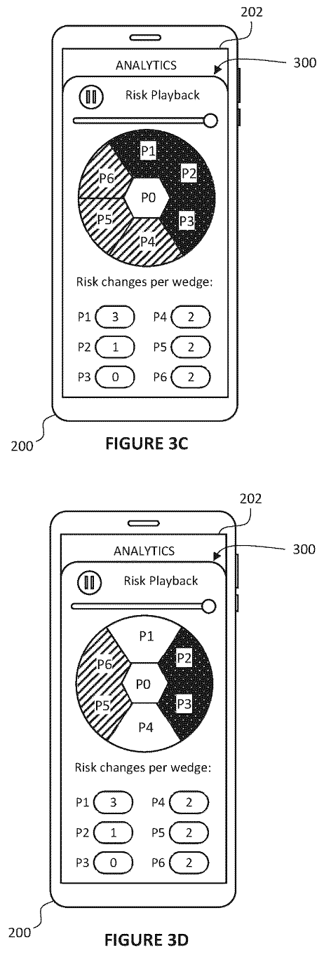

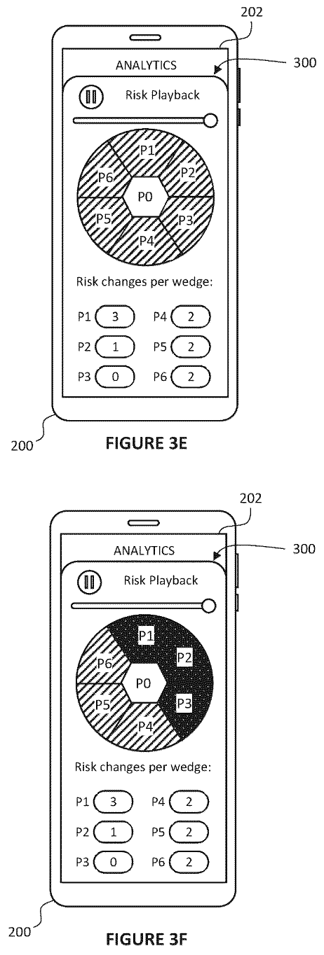

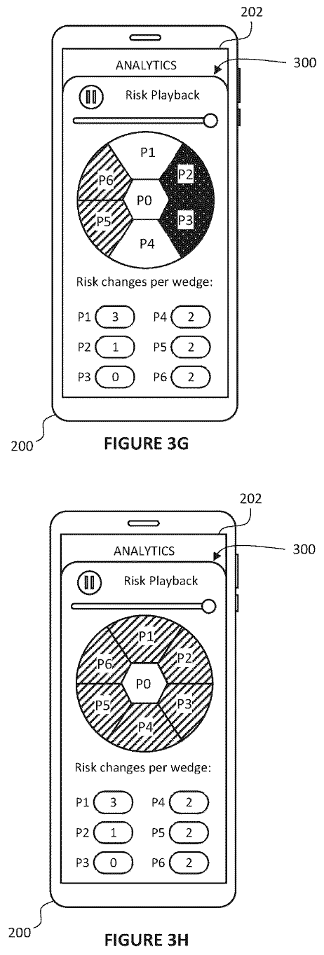

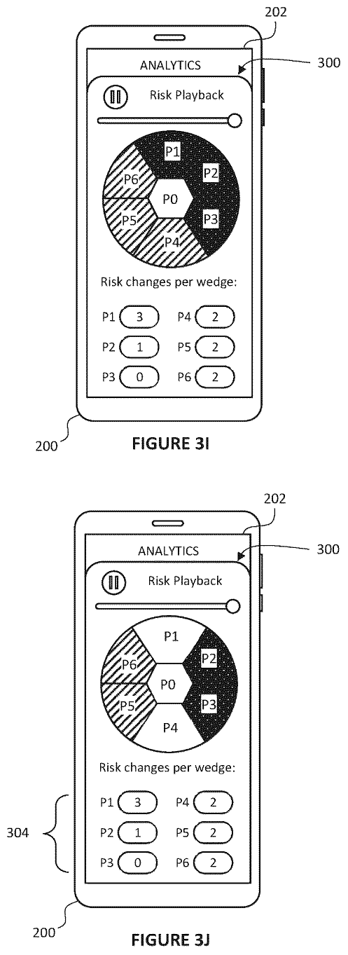

FIGS. 3A-3J are schematics showing the history (generally indicated by 300) of a transaction being displayed on the display region (202) of the FIG. 2 apparatus, in the form of an animation or “replay” (302). FIG. 3A is the start of the replay, i.e. at or near the beginning of the transaction; and FIG. 3J is the end of the replay, i.e. at or near the end of the transaction. The intermediate Figures show how the animation sequentially updates every time there is a change in risk levels associated with one or more of the segments.

As best seen in FIG. 3J, at the bottom of the display region there is a tally (304) showing how many risk level changes in total each of the segments has undergone during the transaction.

Though not shown, other data and/or analytics functions/tools may be available in conjunction with the history replay. For instance, every time a risk level change occurs during the replay, a viewer may be able to call up details of that risk level change. For example, by pausing the video and hovering over the relevant segment to get a written summary of events that prompted the risk level change. The skilled person will appreciate many other ways in which data/information/analytics may be incorporated into the history replay or animation.

Again, the replaying and analytics of the risk history of the transaction may involve interaction between different nodes. For instance, a third-party AI-enabled node may be called to perform the analytics on the transaction. Furthermore, the risk history and analytics may be exportable to third-party nodes (or via third-party functionality) for storage, retrieval and/or viewing.

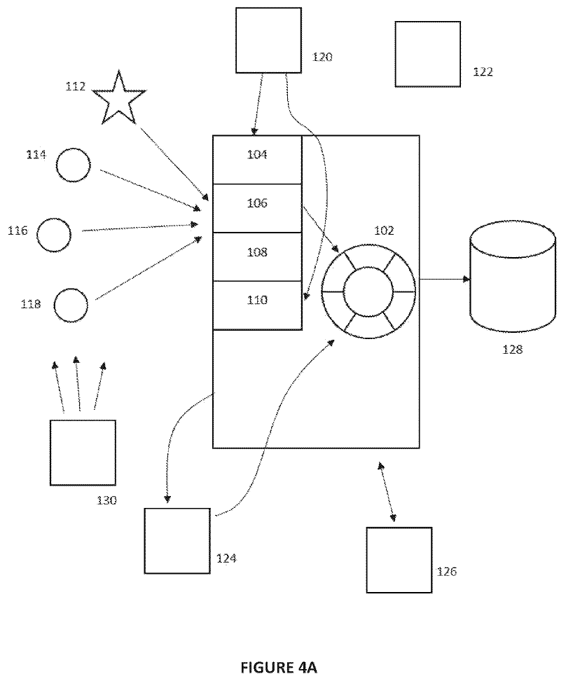

FIG. 4A is an exemplary schematic representing the above-discussed process in relation to a sales transaction. A team of salespeople are involved in the process, including a principal user (112) and a number of other users (114, 116, 118), each of whom is equipped with an apparatus (not shown) configured in accordance with the present invention.

Schematically shown at (100) is the risk profile associated with the sales transaction, with the risk visualization area schematically shown at (102), with each type of risk depicted by a distinct segment. At (104)-(110) are schematically shown the types of inputtable or receivable data associated with the transaction: contextual factors, particularly iPOV and aPOV (104); instructive data (106); indicative data (108); and empirical data (110).

To begin with, the principal user (112) may enter an item of instructive data (106) into the system, that is to say, an instruction as to a risk level that is to be displayed in association with a particular segment i.e., type of risk.

The system may also be configured to obtain data from a number of external nodes—in this embodiment, a first external node (120) which the system is configured to automatically mine/crawl (or instruct the mining/crawling of) for data relevant to the sales transaction, and from which data (depicted here as contextual data (104) and empirical data (110)) is automatically imported; and a second external node (122) which the principal user (112) may selectively call to request the provision of information relating to the sales transaction.

These various inputted or received data points are conveyed to an analysis node (124), which in this embodiment is external to the system, for analysis in accordance with the P6™/RMM methodology. For instance, the analysis node (124) may comprise a third-party AI-enabled functionality (or other suitable protocol). The analysis node (124) processes/analyses the inputted/received data points and computes the appropriate risk level associated with each of the types of risk (i.e. segments). This is relayed back to the system and displayed on the risk visualization area (102).

Optionally, instructive data (106), i.e. a direct instruction as to a segment's risk level, particularly when inputted by the principal user (112), may be inputted directly to the risk visualization area (102) without passing through the analysis node (124). However, this is not intended to be limiting.

At subsequent points in the transaction, i.e. as the transaction progresses, one or more of the other users (116, 118) may input subsequent data. User (116) is shown here as inputting instructive data (106), i.e. data proposing a specific risk-level associated with a segment, while user (118) is shown as inputting indicative data (108), i.e., data relating to circumstances surrounding the sales transaction which may have implications for risk levels.

The external nodes (120, 122) may also input or provide subsequent data in the course of the transaction.

These subsequent data points are, on an ongoing basis, likewise relayed to the analysis node (124) for processing in accordance with the P6™/RMM methodology, and any changes to risk levels, once calculated, are displayed on the risk visualization area (102). All the users (112-118) see the changes on the risk visualization area (102) of their respective apparatuses (not shown).

In the course of this process, as information relating to the transaction changes—for instance, as new information comes in, as a user makes a proposition/comment/challenge, or as there is a change to risk levels—a messaging node (130) alerts the users (112-118) of this, such that all users are up to date and equipped with near-instantaneous information as to the sales transaction and the other team members' views on same.

At the conclusion of the sales transaction (or even during the transaction), a transaction history analytics node (126) is called by the system, which processes and generates a) a display (such as a replay or animation) of the history of the transaction, and b) analytics to do with the history of the transaction. This is transmitted back to the system and is selectively viewable by the users (112-118).

Finally, a storage node (128) is utilized for the storage of all information pertaining to the sales transaction, from where it can be selectively retrieved and accessed by the users (112-118).

It will be understood that all and any modifications or variations to the present invention herein described that would be apparent to a person skilled in the art are deemed to fall within the broad scope and ambit of the present invention.

The present invention may also broadly be the to consist in the parts, elements and features referred to or indicated herein, individually or collectively, and any or all combinations of any two or more of the parts, elements or features. Where specific integers are mentioned herein which have known equivalents, such equivalents are deemed to be incorporated herein as if individually set forth.

To avoid doubt, it will be understood that where a product, device, system, method, or process as herein described is sold, offered for sale or otherwise provided incomplete, as an individual component, or as a “kit of parts”, such exploitation is deemed to fall within the ambit of the present invention.

Throughout the present specification, reference to a “skilled person”, “skilled addressee”, or “person skilled in the art” should be understood as referring to a practitioner having ordinary skill in the relevant field but implementing this in an unimaginative manner. It will be appreciated that a degree of trial and experimentation may fall within the ambit of the practice of the skilled addressee when performing the invention disclosed herein.

Throughout the present specification, any references to “comprise” and derivatives of that term are to be interpreted inclusively. That is to say, references to “comprise” will be taken to include not only any listed components directly referenced in a given case, but also other non-specified components or elements. This applies whether the term “comprise” is used in relation to a product, device, system, one or more steps in a method or process, or any other aspect of the invention herein disclosed. To avoid doubt, “comprise” is not to be ascribed an exclusive meaning; that is to say, it is not to be taken to exclude any features, components, integers or steps merely due to their not being explicitly mentioned.

Similarly, the terms “including and having” or “having and including”, if used herein, are to be defined inclusively.

Throughout the present specification, the terms “upper”, “up”, “lower”, “down”, “right”, “left”, “vertical”, “horizontal”, “top”, “bottom”, “lateral”, “longitudinal”, “side”, “front”, “rear”, and derivatives thereof shall relate to the present invention as it is oriented in the Figures. However, it is to be understood that the present invention may from time to time assume various alternative orientations, except where expressly specified to the contrary. In any given case, reference to the above-listed terms should be accorded the meaning reasonably indicated by the context.

All references cited in this specification, including any patent or patent application, or any document, act, or item of knowledge, are hereby incorporated by reference. The discussion of these references states what their authors (or proponents) assert. No admission is made that any reference constitutes valid prior art; neither is any admission made as to the accuracy or pertinency of any reference. All rights to challenge the accuracy, pertinency and/or validity as prior art of any reference are hereby reserved.

What is claimed is:

1. An electronic apparatus configured to facilitate management of risks associated with a business-to-business (B2B) sales transaction, the apparatus comprising or communicable with a server having a memory, and a processor configured to execute server instructions, the apparatus configured to, in use:
display, on a display region, a risk visualization area subdivided into at least six distinct segments, each distinct segment representing a unique type of risk associated with the sales transaction, and
display, in relation to each segment, an indication of a risk level, the risk level being based on inputted or received data relating to the sales transaction;
the apparatus further configured to, in response to subsequently inputted or received data, display an updated indication of the risk level in relation to one or more of the segments; and
wherein the risks are related to at least the following types of risks according to RMM methodology: P1 (problem); P2 (payback); P3 (pressure point); P4 (politics); P5 (positional); P6 (process).

2. The apparatus of claim 1, wherein at least the P6 type of risk is an aggregate of multiple subtypes of process risk, including decision process risk, buying process risk and internal process risk.

3. The apparatus of claim 1, wherein the indication of the risk level associated with each distinct segment is provided by a color code, wherein each color corresponds to a predetermined level of risk.

4. The apparatus of claim 1, wherein the display region is also configured to display a risk contextualization portion (P0), the risk contextualization portion representing contextual factors potentially impacting one or more of the types of risk, the contextual factors including iPOV, aPOV, and ACP; wherein the risk contextualization portion is provided as an additional, central, segment on the risk visualization area.

5. The apparatus of claim 1, wherein the inputted or received data and the subsequently inputted or received data comprises one or more of:
instructive data specifying the risk level associated with one or more types of risk;
indicative data relating to circumstances surrounding the sales transaction; and
empirical data relating to the sales transaction.

6. The apparatus of claim 4, wherein the inputted or received data and the subsequently inputted or received data further comprises the contextual factors.

7. The apparatus of claim 5, wherein at least one of: the indicative data; and the empirical data, is obtained from an external data node.

8. The apparatus of claim 1, wherein the server is configured to process the inputted or received data and the subsequently inputted or received data to determine a risk level in relation to one or more of the segments.

9. The apparatus of claim 8, wherein the server is configured to cause an external processing node to perform the processing of the inputted or received data and the subsequently inputted or received data, wherein the processing occurs using artificial intelligence (AI) or another suitable protocol.

10. The apparatus of claim 1, wherein the risk management of the sales transaction is effected by a principal user and at least one other authorized user; wherein each of the principal user and the at least one other authorized user may input data relating to the sales transaction.

11. The apparatus of claim 10, wherein the apparatus enables the principal user to accept or reject the inputted data from the at least one other authorized user.

12. The apparatus of claim 10, wherein the server is configured to cause an external communications node to send messages or alerts to each of the principal user and the at least one other authorized user pertaining to the risk management of the sales transaction.

13. The apparatus of claim 1, wherein the apparatus is further configured to display a history of the sales transaction or a part of same, via one or more of: displaying a written summary of the history of the sales transaction; displaying a visualization of the history of the sales transaction; or displaying an animation of the history of the sales transaction.

14. The apparatus of claim 13, wherein the server is configured to cause an external transaction history analytics node to generate and display the history of the sales transaction or a part of same.

15. The apparatus of claim 1, wherein the apparatus comprises a personal electronic device such as a smartphone, tablet, or laptop.

16. A method for facilitating management of risks associated with a business-to-business (B2B) sales transaction, using the electronic apparatus of claim 1, the method comprising:
displaying a risk visualization area subdivided into at least six distinct segments, each distinct segment representing a unique type of risk associated with the sales transaction, wherein the risks are related to at least the following types of risks according to RMM methodology: P1 (problem); P2 (payback); P3 (pressure point); P4 (politics); P5 (positional); P6 (process); and
displaying, in relation to each segment, an indication of a risk level, the risk level being based on inputted or received data relating to the sales transaction;
the method further comprising, in response to subsequently inputted or received data, displaying an updated indication of the risk level in relation to one or more of the segments.

17. The method of claim 16, wherein the risk management of the sales transaction is effected by a principal user and at least one other authorized user; wherein each of the principal user and the at least one other authorized user may input data relating to the sales transaction.

18. The method of claim 17, wherein each of the principal user and the at least one other authorized user utilize the electronic apparatus configured to facilitate management of risks associated with a business-to-business (B2B) sales transaction, the apparatus comprising or communicable with a server having a memory, and a processor configured to execute server instructions, the apparatus configured to, in use:
display, on a display region, a risk visualization area subdivided into at least six distinct segments, each distinct segment representing a unique type of risk associated with the sales transaction, and
display, in relation to each segment, an indication of a risk level, the risk level being based on inputted or received data relating to the sales transaction;
the apparatus further configured to, in response to subsequently inputted or received data, display an updated indication of the risk level in relation to one or more of the segments; and
wherein the risks are related to at least the following types of risks according to RMM methodology: P1 (problem); P2 (payback); P3 (pressure point); P4 (politics); P5 (positional); P6 (process).
